(19) United States
(12) Patent Application Publication
(10) Pub. No.: US 2020/0029109 A1
(43) Pub. Date: Jan. 23, 2020

(54) MEDIA PLAYBACK CONTROL THAT CORRELATES EXPERIENCES OF MULTIPLE USERS

(71) Applicant: International Business Machines Corporation, Armonk, NY (US)

(72) Inventors: Ermyas Abebe, Altona (AU); Rajib Chakravorty, Epping (AU); Lenin Mehedy, Doncaster East (AU)

(21) Appl. No.: 16/042,456

(22) Filed: Jul. 23, 2018

(51) Int. Cl. H04N 21/2343; H04N 21/25; H04N 21/258; H04N 21/8405

(52) U.S. Cl. CPC H04N 21/234345; H04N 21/8405; H04N 21/25891; H04N 21/252

(57) ABSTRACT

A system, method and program product for system for processing audio visual (AV) content items during playback. A system is disclosed that includes: a controller for selecting a content item and filtering the content item during playback based on filtering parameters; an audience identification system that identifies members of an audience intended to view the content item and obtains user attributes of each member of the audience; and a filtering manager that calculates the filtering parameters based on the user attributes and metadata tags associated with the content item, wherein the metadata tags are obtained from a remote metadata repository that generates metadata tags from feedback obtained from participating system users.

### TECHNICAL FIELD

The subject matter of this invention relates to controlling media playback, and more particularly to a system and method of controlling media playback by correlating experiences of multiple users in various contexts.

### BACKGROUND

Audio visual (AV) content, including movies, television programs, streaming media, etc., continues to evolve with the proliferation of Web-based services and smart devices. Users of any type are able to access content in an on-demand fashion from any location at any time.

Along with this proliferation however comes greater challenges in filtering inappropriate or undesired content for sensitive viewers, including both children and adults. While most content is subject to ratings, such as G, PG, R, etc., such a holistic approach to rating content may not provide the “entire picture” for the consumer. The emotional journey one goes through while consuming media is a personal experience and cannot be captured in such a rating system. For example, one viewer may be fine viewing a highly graphic scene, while another may find it disturbing.

For example, a father may decide to watch a PG rated movie with his daughter, believing that the content is acceptable. The daughter however may have a high sensitivity to horror scenes, of which there is a small scene in the movie. While the overall movie may be acceptable, the father would prefer that they skip any scenes that could potentially upset his daughter. Unfortunately, there is no easy way to know ahead of time whether such a scene exists or where it is in the movie.

### SUMMARY

Aspects of the disclosure provide a system and method to filter specific segments during playback of video content based on emotional tags associated with those segments. In one aspect, a system is provided that identifies an audience and predicts the emotional sensitivity of an individual or group of individuals in the audience. The system then determines which segment of the video content is “not suitable” for the audience and takes appropriate actions.

A first aspect discloses a system for processing audio visual (AV) content items during playback, comprising: a controller for selecting a content item and filtering the content item during playback based on filtering parameters; an audience identification system that identifies members of an audience intended to view the content item and obtains user attributes of each member of the audience; and a filtering manager that calculates the filtering parameters based on the user attributes and metadata tags associated with the content item, wherein the metadata tags are obtained from a remote metadata repository that generates metadata tags from feedback obtained from participating system users.

A second aspect discloses a computer program product stored on a computer readable storage medium, which when executed by a computing system, provides processing of audio visual content, the program product comprising: program code for selecting a content item and filtering the content item during playback based on filtering parameters; program code that identifies members of an audience intended to view the content item and obtains user attributes of each member of the audience; and program code that calculates the filtering parameters based on the user attributes and metadata tags associated with the content item, wherein the metadata tags are obtained from a remote metadata repository that generates metadata tags from feedback obtained from participating system users.

A third aspect discloses a method of processing of audio visual content, the method comprising: selecting a content item; identifying members of an audience intended to view the content item; obtaining user attributes of each member of the audience; calculating filtering parameters based on the user attributes and metadata tags associated with the content item, wherein the metadata tags are obtained from a remote metadata repository that generates metadata tags from feedback obtained from participating system users; and filtering the content item during playback based on the filtering parameters.

### BRIEF DESCRIPTION OF THE DRAWINGS

These and other features of this invention will be more readily understood from the following detailed description of the various aspects of the invention taken in conjunction with the accompanying drawings in which:

FIG. 1 shows a computing system having a media processor according to embodiments.

FIG. 2 shows a flow chart of a method of implementing the media processor according to embodiments.

FIG. 3 shows a media system according to embodiments.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

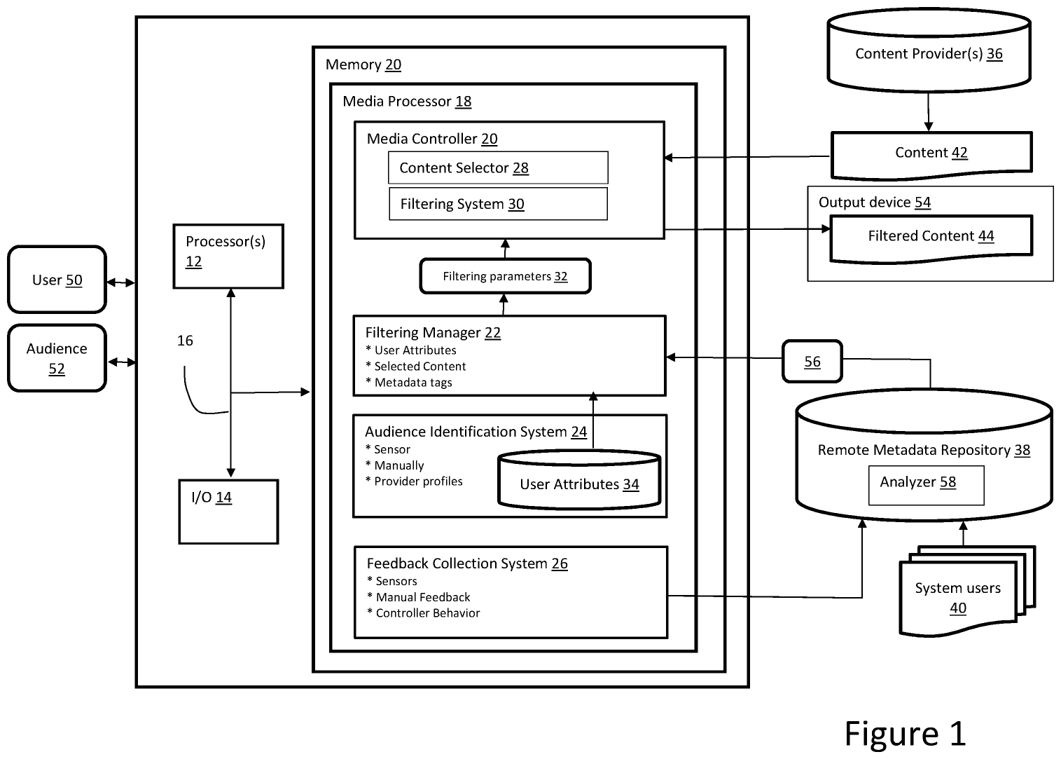

Referring now to the drawings, FIG. 1 depicts a computing system 10 having a media processor 18 that allows for the filtering of audio video (AV) content 42 based on the audience 52 and emotionally-based metadata tags 56 associated with the content 42. In an embodiment, media processor 18 provides a process in which segments (e.g., scenes, sections, chapters, displayed regions, audio portions, etc.) of a stream of content 42 can be filtered (i.e., altered, removed, blocked, skipped, blurred, volume adjusted, etc.) based on the audience 52 viewing the content. In particular, potentially unwanted material in the content is identified for the current audience 52 based on feedback of other users and is then filtered out. For example, a violent scene in a movie may be automatically skipped if the audience 52 includes an individual that is overly sensitive to such material.

Media processor 18 generally includes a media controller 20 having a content selector 28 that allows a user 50 to select, control and play content 42 from content providers 36. Media controller 20 may for example be implemented with a graphical user interface (GUI) using traditional radio buttons and controls found on common media controllers (e.g., play, fast-forward, back, select, etc.). Additionally, media controller 20 includes a filtering system 30 that causes the selected content 42 to be played on an output device 54 (e.g., a TV, computer, smartphone, tablet, etc.) as filtered content 44, based on a set of filtering parameters 32.

Filtering parameters 32 are determined from a filtering manager 22 based on user attributes 34, the selected content 42, and metadata tags 56 associated with the selected content 42. Filtering parameters 32 may for example provide a time sequence in the content 42 (e.g., time=1:03:45-1:04:11)), a region (e.g., pixels xy1-xy2) and/or a type of filtering to be applied (e.g., skip, block, shade, etc.).

User attributes 34 may for example include information about the audience 52, e.g., identity, age, gender, tolerances, etc., which may be gathered and maintained by an audience identification system 24. Audience identification may be accomplished in any manner. For example, the user 50 may manually enter/select the members of the audience 52, e.g., with a dropdown box that lists the members of a household. Further, members of the audience 52 may be detected with sensors (e.g., facial recognition, voice recognition, etc.). Still further, members of the audience 52 may be identified based on profiles set up with the content provider 36 (e.g., based on user names in NETFLIX®, etc.).

As noted, each user attribute 34 may include information such an identity, age, gender, tolerance settings, etc., which allows the filtering manager 22 to determine whether any filtering should be applied for a given piece of content. For example, the following two user attributes 34 that make up an audience 52 may be collected and stored as follows:

```
<User 1> = dad
    <role> = parent
    <age> = 36
    < tolerance settings>
        <violence> = high
        <horror> = high
        <graphic depictions> = medium
<User 2> = kid
    <role> = child
    <age> = 8
    < tolerance settings>
        <violence> = none
        <horror> = low
        <graphic depictions> = none
```

In these examples, tolerance settings are provided for categories of sensitive material that include violence, horror and graphic depictions. Any number of other categories could likewise be utilized (e.g., embarrassment, surprise, nudity, etc.). In this example, “kid” has no tolerance for violence or graphic depictions, and a low tolerance for horror, while “dad” has high tolerance for violence and horror and medium tolerance for graphic depictions. The settings may be established in any manner, e.g., based on age, user inputs, gender, demographics, past behaviors, etc.

Metadata tags 56 are obtained from a remote metadata repository 38 that calculates and stores tags 56 based on feedback gathered from participating system users 40. Thus for example, for a given movie, a metadata tag 56 determined from feedback provided by other viewers in the past might indicate that a particular scene in the movie contains material that might be emotionally upsetting to children under the age of seven.

In the same manner, the current user 50 shown in FIG. 1 may also provide feedback to the repository 38, e.g., via a feedback collection system 26. Feedback collection system 26 may utilize: sensors that capture reaction information of content being displayed; manual feedback such as natural language input collected by the media processor 18 or an external system such as a social media website; and/or via detected controller behavior (e.g., fast-forwarding through a scene, lowering the volume, etc.). Sensors may for example include wearable sensors that measure heart rate, posture, facial expressions, sounds, etc. Manual feedback may for example comprise a review, such as “my daughter screamed during the forest scene . . . .”

The feedback information is fed back to the remote metadata repository 38 where an analyzer 58 collects and correlates feedback for different content viewed by the system users 40 and generates metadata tags 56. Metadata tags 56 may be calculated based on all the feedback information collected in the repository 38, or based on different subsets of information, e.g., people in the same social media groups, etc. Metadata tags 56 may for example be implemented as follows:

```
<Content Item> = Movie xyz
    <Tag 1> = violence
        <Time Sequence> 1:05:03 - 1:05:34
            <Pixel Region> xy1 - xy2
            <intensity> high
        <Time Sequence > 1:15:04 - 1:65:30
            <Pixel Region> all
            <intensity> medium
    <Tag 2> = horror
        <Time Sequence > 0:16:04 - 0:25:30
            <Pixel Region> all
```

In this example, the content item (Movie xyz) includes a violence tag at two different time sequences, and a horror tag at during one time sequence. A pixel region, intensity, and any other relevant information may also be included. As noted, the metadata tags may be compiled based on feedback of other users that viewed the same content. When content 42 is selected by the user 50, filtering manager 22 loads the metadata tags 56 from the remote metadata repository for the selected content 42. The metadata tags 56 are then correlated with the user attributes 34 to calculate the filtering parameters 32, e.g., based on a set of rules. For instance, if a user attribute 34 includes a low tolerance to violence, and the metadata tag 56 indicates a time sequence with a high degree of violence, then that time sequence and an appropriate filtering operation can be captured in a filtering parameter 32 for use by the filtering system 30 of the media controller 20 (e.g., to lower the volume during the identified time sequence).

Consider a scenario in which a user 50 “Eric” selects a movie to watch with his six year old son. The audience identification system 24 detects the viewers, their ages and other attributes (e.g., father and son) based on previously saved information (e.g., faces, registered wearable devices with RFID tags, etc.). The filtering manager 22 collects previously calculated metadata tags 56 (e.g., based on user ratings, emotions of previous dads watching with kids, etc.) of that movie from a cloud service (i.e., repository 38). The cloud service generates the metadata tags 56 based on previously collected feedback, e.g., mental states of people from Eric's social network and correlated personalities. The filtering manager 22 identifies segments that may not be suitable for Eric's son and provides the information to the filtering system 30 to filter the content during playback.

In one embodiment, prior to playback, the media controller 20 can inform Eric that there will be a five minute censorship in the movie and its reasoning, which Eric can accept or decline before the controller starts the movie. In a further embodiment, the media controller 20 can prompt Eric during playback to respond to or take actions during different segments of the movie. Such actions may include: fast forward, reduce volume, darken the screen, show a summarization of that segment over a black screen as text, etc. If there is no available ways to get Eric's input after a prompt, the media controller 20 may choose a default playback options such as “mute and darken the screen with scene summarization.”

During playback, feedback collection system 26 may collect emotional state information from Eric and the son and upload it to the cloud service for processing and metadata tag 56 generation. Additionally, feedback collection system 26 may also prompt Eric for natural language input about the movie and/or automatically collect reaction data from sensors obtained during the movie.

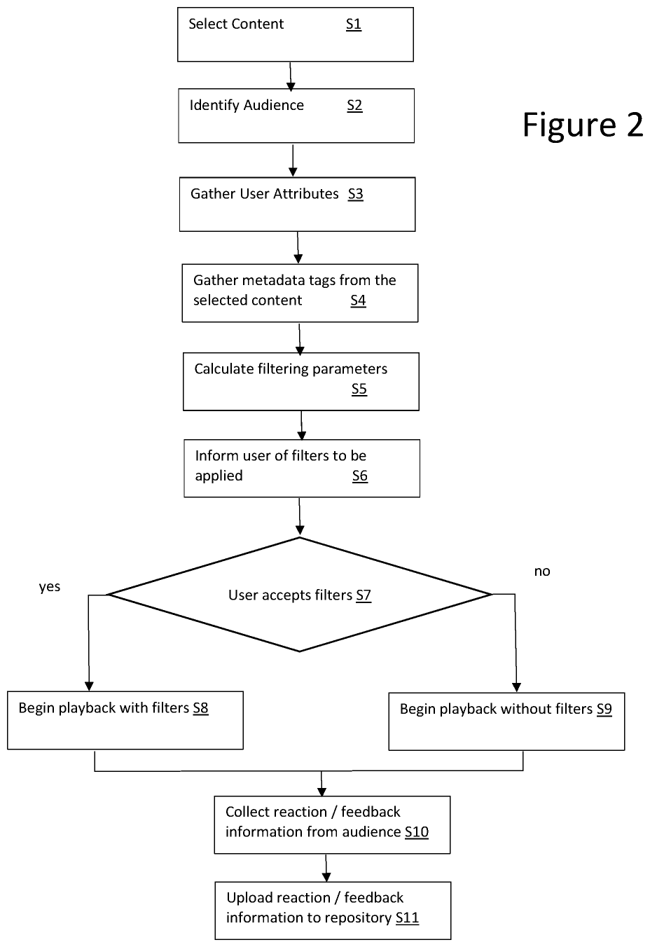

FIG. 2 depicts an illustrative method of implementing the media processor 18 of FIG. 1. At S1, content 42 from a content provider 36 is selected by a user, and at S2, members of the audience 52 are identified using audience identification system 24. At S3, user attributes 34 of the audience 52 are gathered and at S4 metadata tags 56 are gathered from the remote metadata repository 38 for the selected content 42. At S5, filtering parameters 32 for the audience 52 and selected content 42 are calculated. Filtering parameters 32 may be calculated using a set of rules that dictate, e.g., how to handle multiple viewers, what type of filtering to apply for a given viewer, default settings, etc. Next, at S6, the user 50 is informed of the filters to be applied and at S7 the user can accept or reject the filtering. If accepted, playback begins with the filters applied at S8. If rejected, playback begins without the filters applied at S9. Note that this embodiment provides opt in/opt out approach to applying filters. However, an alternative embodiment may be employed that allows the user to select different types or levels of filtering (e.g., default filtering, prompt-based filtering where the user is prompted during the movie to take an action, etc.). At S10, feedback information is collected from the audience using feedback collection system 26 and at S10 the feedback information is uploaded to the remote metadata repository 38 for analysis at S11.

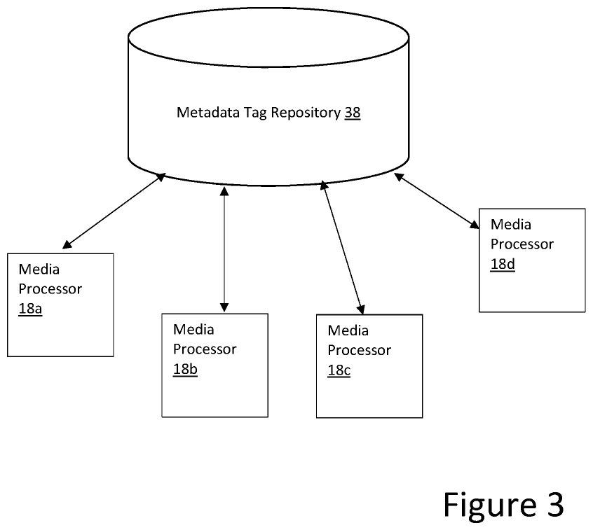

FIG. 3 depicts a media system infrastructure 60 that shows the remote metadata repository 38 in communication with a group of media processors 18a-18d. Each of the media processors 18a-18d is intended to depict an instance of the media processor 18 shown in FIG. 1, which is controlled by a subscribing user. In other words, each subscribing user is capable of independently selecting content and obtaining metadata tags from the repository 38 using a media processor 18a-18d. Feedback from participating system users (i.e., audience members and/or users) associated with media processor 18a-18d is likewise collected by the repository 38 to generate/update metadata tags for content viewed by an associated audience.

It is understood that media processor 18 may be implemented as a computer program product stored on a computer readable storage medium. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Python, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Computing system 10 that may comprise any type of computing device and for example includes at least one processor 12, memory 21, an input/output (I/O) 14 (e.g., one or more I/O interfaces and/or devices), and a communications pathway 16. In general, processor(s) 12 execute program code which is at least partially fixed in memory 21. While executing program code, processor(s) 12 can process data, which can result in reading and/or writing transformed data from/to memory and/or I/O 14 for further processing. The pathway 16 provides a communications link between each of the components in computing system 10. I/O 14 can comprise one or more human I/O devices, which enable a user to interact with computing system 10. Computing system 10 may also be implemented in a distributed manner such that different components reside in different physical locations.

Furthermore, it is understood that the media processor 18 or relevant components thereof (such as an API component, agents, etc.) may also be automatically or semi-automatically deployed into a computer system by sending the components to a central server or a group of central servers. The components are then downloaded into a target computer that will execute the components. The components are then either detached to a directory or loaded into a directory that executes a program that detaches the components into a directory. Another alternative is to send the components directly to a directory on a client computer hard drive. When there are proxy servers, the process will select the proxy server code, determine on which computers to place the proxy servers' code, transmit the proxy server code, then install the proxy server code on the proxy computer. The components will be transmitted to the proxy server and then it will be stored on the proxy server.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

1. A system for processing audio visual content items during playback, comprising:
a controller for selecting a content item and filtering the content item during playback based on filtering parameters;
an audience identification system that identifies members of an audience intended to view the content item and obtains user attributes of each member of the audience; and
a filtering manager that calculates the filtering parameters based on the user attributes and metadata tags associated with the content item, wherein the metadata tags are obtained from a remote metadata repository that generates metadata tags from feedback obtained from participating system users, wherein the feedback includes controller behavior of other system users, wherein the feedback includes a mental state of other system users in a social network of a member.

2. The system of claim 1, wherein the filtering parameters identify a segment of the content item to be filtered.

3. The system of claim 2, wherein the user attributes include tolerance settings for at least one category of material including: violence, horror, graphic material, surprise, and embarrassment.

4. (canceled)

5. The system of claim 1, wherein the filtering parameters further include a type of filtering to be applied to the content item selected from a group consisting of: skipping, blurring, blacking out, volume adjusting, altering, removing, or blocking.

6. The system of claim 1, further comprising a feedback collection system that collects feedback from the audience and uploads the feedback to the remote metadata tag repository.

7. The system of claim 6, wherein the feedback collection system utilizes at least one of: a sensor that detects audience reactions, natural language input, or detected behavior of the controller during playback.

8. A computer program product stored on a computer readable storage medium, which when executed by a computing system, provides processing of audio visual content, the program product comprising:
program code for selecting a content item and filtering the content item during playback based on filtering parameters;
program code that identifies members of an audience intended to view the content item and obtains user attributes of each member of the audience; and
program code that calculates the filtering parameters based on the user attributes and metadata tags associated with the content item, wherein the metadata tags are obtained from a remote metadata repository that generates metadata tags from feedback obtained from participating system users, wherein the feedback includes controller behavior of other system users, wherein the feedback includes a mental state of other system users in a social network of a member.

9. The program product of claim 8, wherein the filtering parameters identify a segment of the content item to be filtered.

10. The program product of claim 9, wherein the user attributes include tolerance settings for at least one category of material including: violence, horror, graphic material, surprise, and embarrassment.

11. (canceled)

12. The program product of claim 8, wherein the filtering parameters further include a type of filtering to be applied to the content item selected from a group consisting of: skipping, blurring, blacking out, volume adjusting, altering, removing, or blocking.

13. The program product of claim 8, further comprising program code that collects feedback from the audience and uploads the feedback to the remote metadata tag repository.

14. The program product of claim 13, wherein the feedback is obtained from at least one of: a sensor that detects audience reactions, natural language input, or detected behavior of the controller during playback.

15. A method of processing of audio visual content, the method comprising:
selecting a content item;
identifying members of an audience intended to view the content item;
obtaining user attributes of each member of the audience;
calculating filtering parameters based on the user attributes and metadata tags associated with the content item, wherein the metadata tags are obtained from a remote metadata repository that generates metadata tags from feedback obtained from participating system users, wherein the feedback includes controller behavior of other system users, wherein the feedback includes a mental state of other system users in a social network of a member; and
filtering the content item during playback based on the filtering parameters.

16. The method of claim 15, wherein the filtering parameters identify a segment of the content item to be filtered.

17. The method of claim 16, wherein the user attributes include tolerance settings for at least one category of material including: violence, horror, graphic material, surprise, and embarrassment.

18. (canceled)

19. The method of claim 15, wherein the filtering parameters further include a type of filtering to be applied to the content item selected from a group consisting of: skipping, blurring, blacking out, volume adjusting, altering, removing, or blocking.

20. The method of claim 15, further collecting feedback from the audience and uploading the feedback to the remote metadata tag repository.

21. The method of claim 15, wherein the feedback is obtained from at least one of: a sensor that detects audience reactions, natural language input, or detected behavior of the controller during playback.

22. The system of claim 1, wherein the feedback includes a correlation of a personality of other system users correlated with a member personality.

23. The program product of claim 8, wherein the feedback includes a correlation of a personality of other system users correlated with a member personality.
